(19) United States
(12) Patent Application Publication
(10) Pub. No.: US 2011/0147371 A1
(43) Pub. Date: Jun. 23, 2011

(54) ENERGY SUPPLYING APPARATUS USING MAGNETIC RESONANCE, COOKING APPARATUS USING MAGNETIC RESONANCE AND METHOD USING THE SAME

(75) Inventor: In Kui CHO, Daejeon (KR)

(73) Assignee: ELECTRONICS AND TELECOMMUNICATIONS RESEARCH INSTITUTE, Daejeon (KR)

(21) Appl. No.: 12/878,678

(22) Filed: Sep. 9, 2010

(30) Foreign Application Priority Data
Dec. 21, 2009 (KR) 10-2009-0127912

(51) Int. Cl. H05B 6/12

(52) U.S. Cl. 219/620

(57) ABSTRACT

An energy supplying apparatus using magnetic resonance, which supplies energy required for cooking to a cooking apparatus, includes a high frequency generation unit for converting input power into high-frequency power in response to a cooking start signal. Further, the energy supplying apparatus using the magnetic resonance includes a transmission-side magnetic resonance circuit for performing resonance by the high-frequency power to produce a magnetic field and transmitting the produced magnetic field to the cooking apparatus to generate the energy.

### CROSS-REFERENCE TO RELATED APPLICATION(S)

The present invention claims priority of Korean Patent Application No. 10-2009-0127912, filed on Dec. 21, 2009, which is incorporated herein by reference.

### FIELD OF THE INVENTION

The present invention relates to a cooking apparatus using magnetic resonance and a method using the same; and more particularly, to an apparatus, which is capable of generating energy using magnetic resonance and performing cooking using the generated energy, and a method using the same.

### BACKGROUND OF THE INVENTION

As well-known in the art, there are many kinds of cooking appliances for home use. That is, these appliances include an electric oven, a microwave oven, and an induction cooker which use electricity as a fuel, a gas range which uses a town gas or LPG as a fuel and the like.

While the electric oven, the microwave oven, or the induction cooker uses heat generated in a heater or high-frequency waves oscillated in a high frequency oscillator, the gas range transfers heat generated by burning gas to the inside of a cavity for receiving food, and heats to cook the food received in the cavity.

Recently, in many cases, further functions are added to the cooking appliances, such as the electric oven or the microwave oven. As one example, for the microwave oven, it is a recent trend that there is an increasing development of a composite cooking apparatus which heats food by radiating and converting heat generated from a heat generation unit such as a heater, as well as performing cooking by friction-heating molecules of a food or beverage using high-frequency waves oscillated from a high frequency oscillator.

Further, the induction cooker uses inductive heating for cooking, in which a coil made of a cooper wire is placed underneath a cooking pot. When the high-frequency power (e.g., current) is applied to the coil, it produces an oscillating magnetic field. The produced magnetic field induces a current in the electrically conductive cooking pot (e.g., pot, frying pan or the like), which produces Joule heat. That is, magnetic hysteresis loss is occurred in the ferromagnetic pot by the high-frequency power to generate heat, thereby cooking a food in the pot.

However, the conventional gas range described above emits radon gas which increases cancer risk, and also emits carbon monoxide and carbon dioxide which are harmful gases. Such gases have adverse effects on the health of cooks or homemakers who do the cooking for a long time.

Moreover, the aforementioned induction cooker generates high-frequency energy by an inverter. This high-frequency energy is operated in close proximity to the cooking pot in a manner that it is induced by the coil in the form of a magnetic field, but there is always the problem of electromagnetic waves that cause a part of the magnetic field to be exposed to the vicinity.

Further, although the electric oven and the microwave oven capable of cooking without emitting radon gas or other harmful gases, unlike the gas range, have been widely distributed, the electric oven and the microwave oven still involve a controversy over the harmfulness of the electromagnetic waves.

### SUMMARY OF THE INVENTION

In view of the above, the present invention provides an energy supplying apparatus using magnetic resonance and a cooking apparatus using magnetic resonance, which have at least one magnetic resonance circuit installed in a magnetic resonance cooking mechanism and a cooking pot, respectively, generate energy using the magnetic resonance generated in the magnetic resonance circuit, and perform cooking using the generated energy, and a method using the same.

In accordance with a first aspect of the present invention, there is provided an energy supplying apparatus using magnetic resonance, which supplies energy required for cooking to a cooking apparatus, the apparatus including: a high frequency generation unit for converting input power into high-frequency power in response to a cooking start signal; and a transmission-side magnetic resonance circuit for performing resonance by the high-frequency power to produce a magnetic field and transmitting the produced magnetic field to the cooking apparatus to generate the energy.

In accordance with a second aspect of the present invention, there is provided a cooking apparatus using magnetic resonance, which reacts to an externally produced magnetic field, the cooking apparatus, including: a reception-side magnetic resonance circuit, magnetically coupled to the externally generated magnetic field, for generating high-frequency energy; and a heat generation plate for converting the generated high-frequency energy into thermal energy to generate heat by the converted thermal energy.

In accordance with a third aspect of the present invention, there is provided a cooking method using magnetic resonance, including: converting, at a high frequency generation unit, input power into high-frequency power in response to a cooking start signal; resonating a transmission-side magnetic resonance circuit by the high-frequency power to generate a magnetic field; magnetically coupling a reception-side magnetic resonance circuit to the generated magnetic field to generate high-frequency energy; and converting, at a heat generation plate, the generated high-frequency energy into thermal energy to generate heat.

In accordance with an embodiment of the present invention, at least one magnetic resonance circuit is installed in the magnetic resonance cooking mechanism and the cooking pot, respectively, energy is generated using the magnetic resonance generated in the magnetic resonance circuit, and cooking is performed using the generated energy, thereby solving the problems in the prior arts such as the emission of the radon gas or other harmful gases having adverse effects on the health and the emission of harmful electromagnetic waves.

Further, the energy generated by the magnetic resonance is directly transferred from the magnetic resonance cooking mechanism to the cooking pot so that energy transfer efficiency is high. As a result, the cooking can be performed quickly and safely.

### BRIEF DESCRIPTION OF THE DRAWINGS

The objects and features of the present invention will become apparent from the following description of embodiments, given in conjunction with the accompanying drawings, in which:

FIG. 1 is a block diagram showing a cooking apparatus using magnetic resonance in accordance with an embodiment of the present invention;

FIG. 2 is a detailed block diagram showing the magnetic resonance cooking mechanism and the cooking pot shown in FIG. 1; and

FIG. 3 is a flow chart sequentially showing a cooking method using magnetic resonance in accordance with the embodiment of the present invention.

### DETAILED DESCRIPTION OF THE EMBODIMENT

Hereinafter, embodiments of the present invention will be described in detail with reference to the accompanying drawings which form a part hereof.

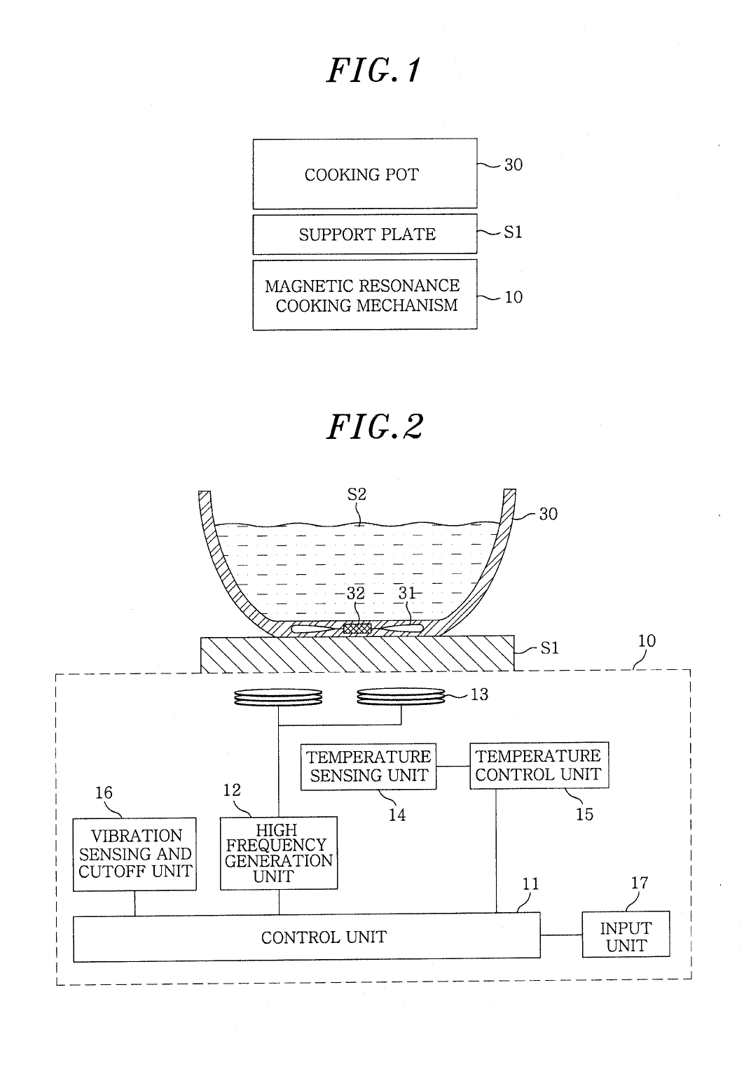

FIG. 1 is a block diagram showing a cooking apparatus using magnetic resonance in accordance with an embodiment of the present invention. The cooking apparatus includes a magnetic resonance cooking mechanism 10 and a cooking pot 30.

The magnetic resonance cooking mechanism 10 is an energy supplying apparatus, which generates energy to actually boil, bake or cook cooking materials put in the cooking pot 30 and transfers the generated energy to the cooking pot 30. As illustrated in FIG. 2, the magnetic resonance cooking mechanism 10 includes a control unit 11, a high frequency generation unit 12, a transmission-side magnetic resonance circuit 13, a temperature sensing unit 14, a temperature control unit 15, a vibration sensing and cutoff unit 16, and an input unit 17.

When receiving a cooking start signal among various signals from the input unit 17, the control unit 11 provides a high-frequency control signal to the high frequency generation unit 12 so that the high frequency generation unit 12 can be operated in response to the input cooking start signal.

Further, the control unit 11 detects signals input from the temperature control unit 15 in real time. Thus, when receiving a non-safety signal, the control unit 11 determines that a safety problem has occurred in the magnetic resonance cooking mechanism 10 to provide the non-safety signal to the vibration sensing and cutoff unit 16.

The high frequency generation unit 12, which is a block comprising, e.g., a high frequency generation circuit or an inverter, is operated depending on the high-frequency control signal input from the control unit 11 to convert external input power (home electric power) into high-frequency power (e.g., current), and provides the high-frequency power generated by conversion to the transmission-side magnetic resonance circuit 13.

The transmission-side magnetic resonance circuit 13 includes at least one magnetic resonance circuit in the magnetic resonance cooking mechanism 10 and makes a pair with a reception-side magnetic resonance circuit 31 located in the cooking pot 30 to use the same resonance frequency. When the transmission-side magnetic resonance circuit 13 is applied with the high-frequency power from the high frequency generation unit 12, it is resonated at a specific applied frequency, thereby generating a magnetic field in the vicinity. The generated magnetic field is transmitted to the cooking pot 30 through a support plate S1. Here, the support plate S1 is located between the magnetic resonance cooking mechanism 10 and the cooking pot 30 so that the cooking pot 30 can be safely supported and protected on the magnetic resonance cooking mechanism 10.

The temperature sensing unit 14 senses the temperature in the magnetic resonance cooking mechanism 10 and provides the sensed temperature to the temperature control unit 15.

The temperature control unit 15 compares the temperature input from the temperature sensing unit 14 with a preset temperature (e.g., a temperature causing an overload to the magnetic resonance cooking mechanism 10) and provides the non-safety signal to the control unit 11 if the input temperature exceeds the preset temperature.

The vibration sensing and cutoff unit 16 senses a vibration signal of the magnetic resonance cooking mechanism 10, determines that a safety problem has occurred in the magnetic resonance cooking mechanism 10 if the sensed vibration signal exceeds a preset vibration signal or the non-safety signal is input from the control unit 11, and cuts off the power supplied to the magnetic resonance cooking mechanism 10.

The input unit 17 inputs the cooking start signal input by a cook to the control unit 11.

The cooking pot 30 refers to a type of cookware, such as a pot, a frying pan, a kettle, and a rice cooker, in which cooking materials are actually cooked. As illustrated in FIG. 2, the cooking pot 30 includes the reception-side magnetic resonance circuit 31 and a heat generation plate 32.

The reception-side magnetic resonance circuit 31 consists of at least one magnetic resonance circuit in the cooking pot 30 and makes a pair with the transmission-side magnetic resonance circuit 13 located in the magnetic resonance cooking mechanism 10 to use the same resonance frequency. The reception-side magnetic resonance circuit 31 has the same resonance frequency as the transmission-side magnetic resonance circuit 13 in the magnetic resonance cooking mechanism 10, is magnetically coupled to the magnetic field transmitted from the transmission-side magnetic resonance circuit 13 using the same resonance frequency to generate high-frequency energy, and provides the generated high-frequency energy to the heat generation plate 32.

When the heat generation plate 32 converts the high-frequency energy input from the reception-side magnetic resonance circuit 31 into thermal energy to generate heat, wherein the generated heat can be used to cook a food S2 in the cooking pot 30.

Thus, the embodiment of the present invention can solve the problems in the prior arts, such as the emission of the radon gas or other harmful gases having adverse effects on the health and the emission of the harmful electromagnetic waves, by having at least one magnetic resonance circuit installed in the magnetic resonance cooking mechanism and the cooking pot, respectively, generating energy using the magnetic resonance generated in the magnetic resonance circuit, and performing cooking using the generated energy.

Next, a cooking process using magnetic resonance in the embodiment of the present invention having the above configuration will be described.

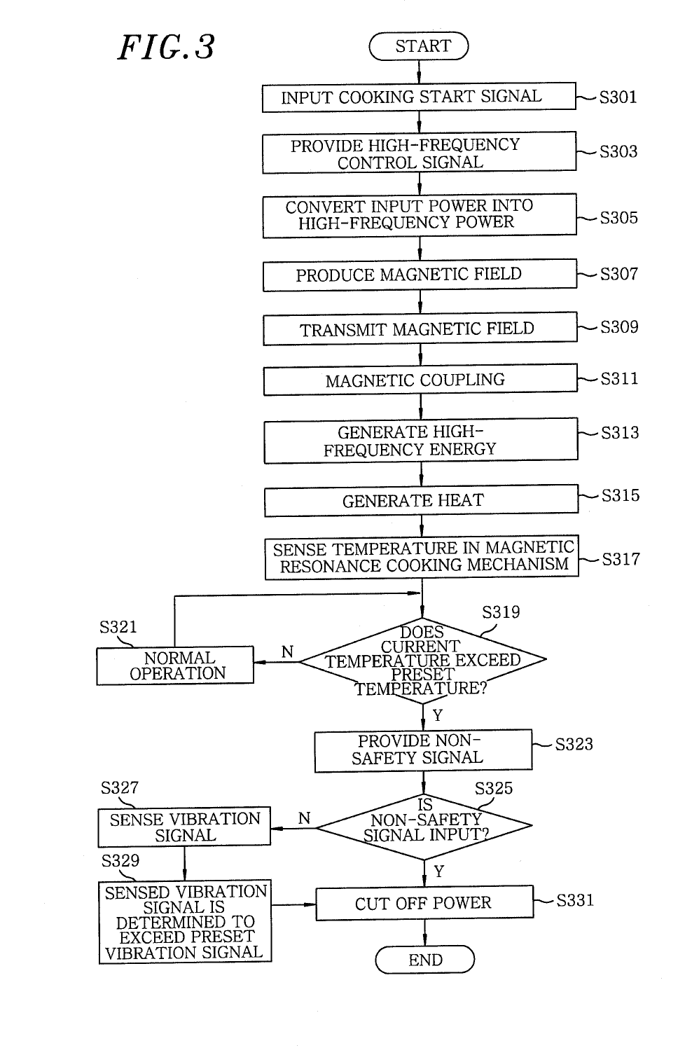

FIG. 3 is a flow chart sequentially illustrating a cooking method using magnetic resonance in accordance with the embodiment of the present invention.

First, the input unit 17 inputs a cooking start signal pressed by the cook, among various signals for cooking, to the control unit 11 in step S301.

When the cooking start signal is received from the input unit 17, the control unit 11 provides a high-frequency control signal to the high frequency generation unit 12 so that the high frequency generation unit 12 is operated in response to the received cooking start signal in step S303.

Then, the high frequency generation unit 12 is operated by the high-frequency control signal input from the control unit 11.

Thereafter, when the high frequency generation unit 12 converts input power into high-frequency power in step S305, the high-frequency power generated by conversion is supplied to the transmission-side magnetic resonance circuit 13.

When the high-frequency power from the high frequency generation unit 12 is applied to the transmission-side magnetic resonance circuit 13, the transmission-side magnetic resonance circuit 13 is resonated at the specific applied frequency, thereby generating a magnetic field in the vicinity in step S307. Most of the generated magnetic field is transmitted to the cooking pot 30 through the support plate S1 in step S309. At this point, part of the non-transmitted energy is not radiated or emitted to the outer space but returns to the transmission-side magnetic resonance circuit 13.

The reception-side magnetic resonance circuit 31 has the same resonance frequency as the transmission-side magnetic resonance circuit 13 in the magnetic resonance cooking mechanism 10, is magnetically coupled to the magnetic field transmitted from the transmission-side magnetic resonance circuit 13 using the same resonance frequency in step S311 to generate high-frequency energy in step S313, and provides the generated high-frequency energy to the heat generation plate 32.

When the heat generation plate 32 converts the high-frequency energy input from the reception-side magnetic resonance circuit 31 into thermal energy to generate heat in step S315, the food S2 in the cooking pot 30 is cooked by the generated heat.

At this time, the temperature sensing unit 14 senses the temperature in the magnetic resonance cooking mechanism 10 in step S317 to provide the sensed temperature to the temperature control unit 15.

The temperature control unit 15 compares the temperature input from the temperature sensing unit 14 with a preset temperature (e.g., a temperature causing an overload to the magnetic resonance cooking mechanism 10) to determine whether the input temperature exceeds the preset temperature in step S319.

As a result of the determination in step S319, if the input temperature does not exceed the preset temperature, the temperature control unit 15 determines that the magnetic resonance cooking mechanism 10 is normally operated in step S321 and continuously determines whether the input temperature exceeds the preset temperature in step S319.

On the other hand, as a result of the determination in step S319, if the input temperature exceeds the preset temperature, the temperature control unit 15 determines that the magnetic resonance cooking mechanism 10 has an overload to provide a non-safety signal to the control unit 11 in step S323.

The control unit 11 detects signals input from the temperature control unit 15 in real time, and, when the non-safety signal is received, determines that a safety problem has occurred in the magnetic resonance cooking mechanism 10 and provides the non-safety signal to the vibration sensing and cutoff unit 16.

The vibration sensing and cutoff unit 16 checks whether the non-safety signal is input from the control unit 11 in step S325.

As a result of the checking in step S325, if the non-safety signal is not input, when the vibration sensing and cutoff unit 16 senses a vibration signal in step S327, it determines that a safety problem has occurred in the magnetic resonance cooking mechanism 10 if the sensed vibration signal exceeds a preset vibration signal in step S329, and cuts off the power supplied to the magnetic resonance cooking mechanism 10 in step S331.

As a result of the checking in step S325, if the non-safety signal is input, the vibration sensing and cutoff unit 16 determines that a safety problem has occurred in the magnetic resonance cooking mechanism 10 to cut off the power supplied to the magnetic resonance cooking mechanism 10 in step S331.

Further, the cooking method using magnetic resonance in accordance with present invention which provides various embodiments as described above may be implemented as computer-executable codes on a computer-readable storage medium. Many kinds of data recording devices that can be read by a computer system may be employed as the computer-readable storage medium. Examples of the computer-readable recording medium include ROM, RAM, CD-ROM, magnetic tape, floppy disk, optical data storage device, a carrier wave (e.g., transmission via Internet and the like), and the like. Further, the computer-executable codes or programs can be distributed and executed by the computer system which is connected to a network to distributively perform the functions of the present invention.

While the invention has been shown and described with respect to the embodiments, it will be understood by those skilled in the art that various changes and modifications may be made without departing from the scope of the invention as defined in the following claims.

What is claimed is:

1. An energy supplying apparatus using magnetic resonance, which supplies energy required for cooking to a cooking apparatus, the apparatus comprising:
a high frequency generation unit for converting input power into high-frequency power in response to a cooking start signal; and
a transmission-side magnetic resonance circuit for performing resonance by the high-frequency power to produce a magnetic field and transmitting the produced magnetic field to the cooking apparatus to generate the energy.

2. The apparatus of claim 1, further comprising:
a temperature sensing unit for sensing a temperature in a main body of the energy supplying apparatus;
a temperature control unit for generating a non-safety signal if the sensed temperature exceeds a preset temperature;
a vibration sensing and cutoff unit for cutting off the input power in response to the non-safety signal; and
a control unit for providing a high-frequency control signal to the high frequency generation unit and providing the non-safety signal to the vibration sensing and cutoff unit when the non-safety signal is received from the temperature control unit.

3. The apparatus of claim 2, wherein the vibration sensing and cutoff unit senses a vibration signal of the main body and cuts off power supplied to a magnetic resonance cooling mechanism if the sensed vibration signal exceeds a preset vibration signal.

4. The apparatus of claim 1, wherein the transmission-side magnetic resonance circuit is comprised of at least one magnetic resonance circuit.

5. The apparatus of claim 4, wherein the transmission-side magnetic resonance circuit returns thereto part of energy which is not transmitted to the cooking apparatus.

6. The apparatus of claim 1, wherein the high-frequency power is converted by a high frequency generation circuit or inverter.

7. A cooking apparatus using magnetic resonance, which reacts to an externally produced magnetic field, the cooking apparatus, comprising:
a reception-side magnetic resonance circuit, magnetically coupled to the externally generated magnetic field, for generating high-frequency energy; and
a heat generation plate for converting the generated high-frequency energy into thermal energy to generate heat by the converted thermal energy.

8. The cooking apparatus of claim 7, wherein the reception-side magnetic resonance circuit comprises at least one magnetic resonance circuit.

9. The cooking apparatus of claim 7, wherein the reception-side magnetic resonance circuit receives the external magnetic field generated by resonance at a specific frequency and couples with the external magnetic field to generate the high-frequency energy.

10. The cooking apparatus of claim 7, further comprising:
a support plate located underneath the reception-side magnetic resonance circuit.

11. A cooking method using magnetic resonance, comprising:
converting, at a high frequency generation unit, input power into high-frequency power in response to a cooking start signal;
resonating a transmission-side magnetic resonance circuit by the high-frequency power to generate a magnetic field;
magnetically coupling a reception-side magnetic resonance circuit to the generated magnetic field to generate high-frequency energy; and
converting, at a heat generation plate, the generated high-frequency energy into thermal energy to generate heat.

12. The cooking method of claim 11, further comprising:
sensing a temperature in a main body of a device for generating the magnetic field; and
cutting off the input power if the sensed temperature exceeds a preset temperature.

13. The cooking method of claim 11, further comprising:
sensing a variation in a main body of a device for generating the magnetic field; and
cutting off the input power if the sensed vibration exceeds a preset value.

14. The cooking method of claim 11, wherein said generating the magnetic field generates the magnetic field by using at least one magnetic resonance circuit.

15. The cooking method of claim 14, wherein said generating the magnetic field returns part of the generated magnetic field which is not transmitted to the reception-side magnetic resonance circuit to the magnetic resonance circuit.

16. The cooking method of claim 11, wherein said generating high-frequency energy generates the high-frequency energy using at least one magnetic resonance circuit.

17. The cooking method of claim 11, wherein the transmission-side magnetic resonance circuit and the reception-side resonance circuit are paired to use the same resonance frequency.

18. The cooking method of claim 11, wherein said converting converts the input power into the high-frequency power by using a high frequency generation circuit or inverter.
